(19) United States
(12) Patent Application Publication
(10) Pub. No.: US 2025/0367055 A1
(43) Pub. Date: Dec. 4, 2025

(54) A PHYSICAL THERAPY CALF STRETCHING EXERCISE AND DEVICE

(71) Applicant: Andrew BULL, East Lindfield (AU)

(72) Inventor: Andrew BULL, East Lindfield (AU)

(21) Appl. No.: 18/876,836

(22) PCT Filed: Jun. 22, 2023
(86) PCT No.: PCT/AU2023/050563

§ 371 Date: Dec. 19, 2024

(30) Foreign Application Priority Data
Jun. 23, 2022 (AU) 2022901730

(51) Int. Cl. A61H 1/02

(52) U.S. Cl. CPC A61H 1/0266; A61H 2201/1253; A61H 2201/164; A61H 2201/168; A61H 2201/169; A61H 2203/0406

(57) ABSTRACT

A physical therapy calf stretching exercise device has two adjacent standing surfaces. These surfaces are inclined at an angle to the ground plane and slope laterally. creating an intersection angle of more than 180°. The exercise involves standing on the device with each foot on a standing surface, which positions the feet in a dorsiflexed varus stance. This stance specifically targets the lateral neuromuscular aspect of the calf. particularly the gastrocnemius muscles that are challenging to isolate with conventional calf stretching exercises. The goal is to enhance the range of motion and flexibility of the lateral calf and nerves.

### FIELD OF THE INVENTION

This invention relates generally to a type of physical therapy calf stretching exercise and device.

### BACKGROUND OF THE INVENTION

Hypermobility is a common a genetic ligament laxity. Hypermobility may be beneficial for contortion sports, including yoga, gymnastics, martial arts, diving, dancing and the like. However, hypermobility causes problems for impact sports involving running and jumping, such as rugby.

Hypermobility is generally more common in females due to oestrogen and progesterone which are “softening” hormones. Furthermore, hypermobility is common in users with Asian, Indian and Pacific Islander ancestry, who may account for half the world's population.

Hypermobility of the ankle is caused by ligament laxity (genetic, functional or post-traumatic) and may create problems of instability in joints, leading to balance and postural problems and an increased risk of dislocations and ligament tears.

Orthotics are commonly used for treating hypermobility of the feet and ankles by limiting the amount of pronation (arch collapsing). Some podiatrists may use heel raising orthotics to treat a hypermobility midfoot bend as a means of increasing heel contact with the ground. However, orthotics prescribed with a heel raise for hypermobile midfoot may exacerbate the problem by tightening the calves further, making it even harder to go barefoot or without orthotics.

The present invention seeks to provide an alternative, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

A physical therapy calf stretching exercise device has two adjacent standing surfaces. These surfaces are inclined at an angle to the ground plane and slope laterally, creating an intersection angle of more than 180°.

The exercise involves standing on the device with each foot on a standing surface, which positions the feet in a dorsiflexed varus stance.

This stance specifically targets the lateral neuromuscular aspect of the calf, particularly the gastrocnemius muscles that are challenging to isolate with conventional calf stretching exercises. The goal is to enhance the range of motion and flexibility of the lateral calf and nerves.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a top perspective view of physical therapy calf stretching exercise device;

FIG. 2 shows a top view of the device;

FIG. 3 shows a side view of the device; and

FIG. 4 shows a front view of the device.

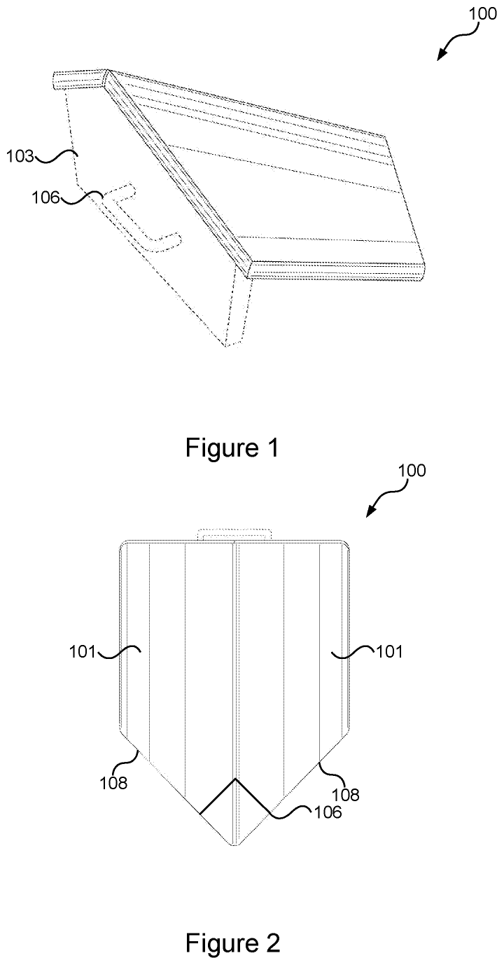

### DESCRIPTION OF EMBODIMENTS

A physical therapy calf stretching exercise device 100 defines adjacent standing surfaces 101.

In the embodiment shown, the device 100 is manufactured from two sideboards 102 and a vertical baseboard 103. A handle 106 may interface the baseboard 103. The sideboards 102 define the standing surfaces 101. The standing surfaces 101 may be texturised with grip. The boards 102 and 103 may be made from low-cost chipboard or the like.

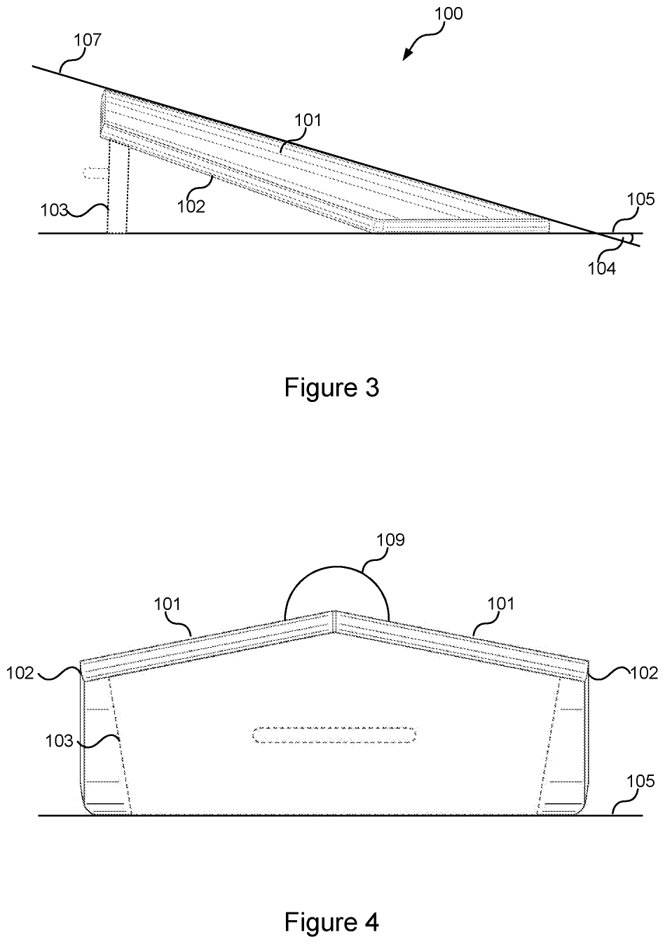

As shown in FIG. 3, an imaginary intersection line 107 defined by the standing surfaces 101 defines an inclination angle 104 with a ground plane 105.

The inclination angle may be between 15 and 35°, more preferably between 20 and 30° and further preferably approximately 25°.

Furthermore, as shown in FIG. 4, the standing surfaces 101 define an intersection angle 109 therebetween of more than 180°.

The intersection angle 109 may be between 200 and 240°, more preferably between 210 235° and further preferably approximately 220°. In other words, each standing surface 101 may slope laterally down from a horizontal plane by approximately 20°.

As shown in FIG. 2, lower edges 108 of the sideboards 102 may define an approximate right angle 106. As such, the device 100 may fit into corners.

Physical therapy calf stretching exercise using the device comprises standing with each foot on a respective standing surface 101 so that inclination and lateral slope of the surfaces 101 acting against the bodyweight of the user holds the feet in a dorsiflexed varus stance, thereby targeting the lateral neuromuscular aspect of the calf, especially the gastrocnemius muscles.

As alluded to above, the device 100 is preferably placed in a corner wherein the lower edges 108 of the sideboards 103 abut against respective corner surfaces. As such, the user can stand against the corner and can lean their back and/or or buttocks against the corner.

Users may be advised to aim for a level of discomfort of between 5 to 7 out of 10 (i.e., a good comfortable stretch). Achieving the appropriate level may comprise stepping off the device 100 and moving the device 100 closer or further away from the corner.

The user may be instructed to shift bodyweight alternately between each foot. The user may be instructed to stand on the device 100 and gently shift bodyweight alternately to each foot, wherein the heel is weight bearing and placed firmly on the board thereby stretching each angle. The user may be instructed to hold a stretch each side for five times each side and for approximately 30 seconds each stretch. As such, the alternate stretching exercises may take approximately five minutes. Furthermore, the user may be instructed to complete these stretches twice a day.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. A physical therapy calf stretching exercise device defining adjacent standing surfaces wherein an intersection line defined by the standing surfaces defines an inclination angle with a ground plane and wherein the standing surfaces slope laterally to define an intersection angle therebetween of between 210 and 230°, and wherein the device defines a right angle between lower edges of the standing surfaces at the ground plane.

2.-6. (canceled)

7. The device as claimed in claim 1, wherein intersection angle is approximately 220°.

8. (canceled)

9. Physical therapy calf stretching exercise using the exercise device as claimed in claim 1, the method comprising placing the lower edges of the surfaces in a corner and standing with at least one of back and buttocks resting against corner surfaces and with each foot on a respective standing surface so that inclination and lateral slope of the surfaces hold the feet in a dorsiflexed varus stance.

10. Physical therapy calf stretching exercise as claimed in claim 9, further comprising standing with the feet approximately hip width apart.

11.-13. (canceled)

14. Physical therapy calf stretching exercise as claimed in claim 9, further comprising shifting bodyweight alternately between each foot.
